(19) United States
(12) Patent Application Publication
(10) Pub. No.: US 2011/0093201 A1
(43) Pub. Date: Apr. 21, 2011

(54) METHOD FOR EVALUATING FLUID PRESSURES AND DETECTING OVERPRESSURES IN AN UNDERGROUND MEDIUM

(76) Inventor: Patrick Rasolofosaon, Les Ulis (FR)

(21) Appl. No.: 12/999,070

(22) PCT Filed: Jun. 10, 2009
(86) PCT No.: PCT/FR2009/000692

§ 371 Date: Dec. 15, 2010

(51) Int. Cl. G01V 1/30; G06F 19/00

(52) U.S. Cl. 702/11; 702/18

(57) ABSTRACT

A method for evaluating fluid pressures and detecting overpressures in an underground medium is disclosed having application to petroleum exploration for detection of overpressure zones while drilling for example. A seismic P wave velocity cube and a seismic S wave velocity cube are constructed by a stratigraphic inversion of seismic data, and a lithology cube identifying argillaceous lithologies and non-argillaceous lithologies is deduced therefrom. A relationship for estimating the fluid pressure from seismic P wave velocities is then determined from well data and for each one of the two lithologies. Finally, the fluid pressures in the underground medium are assessed by constructing a fluid pressure cube by applying the relationship to the seismic P wave velocity cube as a function of the lithology cube.

### BACKGROUND OF THE INVENTION

1. Field of the Invention

The present invention relates to underground reservoir characterization. In particular, the invention relates to a method for quantitative evaluation of fluid pressures in the subsoil including the field of petroleum exploration for the detection of overpressure zones when drilling.

2. Description of the Prior Art

The presence of overpressure zones under exploration can have serious financial and sometimes human consequences during drilling if the fluid pressures are not known. Prediction of the presence of overpressure zones and, more generally, quantitative evaluation of these overpressures has become a priority for oil companies. In fact, in the field of exploration, the fluid pressure can be close to the minimum principal stress and induce the re-opening of fractures or possibly initiate hydraulic fracturing. In the filed of drilling, it is important to know the pressure difference between the fluid pressure and the minimum stress in place for the design of well casings, and to predict the mud weight to prevent blowouts in underbalanced drilling or drilling mud losses in overbalanced drilling. Finally, depletion in overpressure zones can induce notable stress redistributions, possibly with significant consequences on the productivity of reservoirs. Thus, a good quantitative evaluation of the fluid pressures and of their connections with the stress variations is also important in the field of production.

There are many methods allowing quantitative evaluation of fluid pressures from physical measurements and not from modelling including formation tests, drill bit drilling rate, clay density measurements, gas shows, fluid flow rate measurements, wireline logging, etc. Among these methods, the geophysical methods, and more particularly the seismic methods, having a higher spatial resolution than their competitors (gravimetry for example) are the only ones allowing this at a distance from wells. It is therefore essential to best exploit the seismic data.

However, the conventionally used seismic processings of the velocity analysis type have a limited efficiency, mainly because, of their spatial resolution being too weak to be efficiently used for drilling and, because they do not sufficiently account for the lithologic variations, often critical in overpressure phenomena: Reynolds, E. B, 1970, Predicting Overpressured Zones with Seismic Data: World oil, 171, 78-82.

In order to understand these main technical problems, the conventional procedure for quantitative evaluation of overpressures from seismic data is summarily described. The various stages are as follows:

obtaining a seismic velocity model that is as precise as possible, through fine velocity analysis deducing a reference compaction curve (seismic velocity as a function of depth) referred to as “normal compaction” curve (corresponding to the hydrostatic distribution of the fluid pressure); and

interpreting the differences between the compaction curve measured with the seismic method and the normal compaction curve in terms of fluid pressure anomalies where anomalies (or deviations in relation to the hydrostatic distribution) can be positive (overpressures) or negative.

The main problems of these methods are, the relatively low spatial resolution of the conventional methods that make them difficult to use for drilling operations and the implicit assumption according to which any anomalic velocity change is attributed to an overpressure, while dismissing for example causes such as the lithology change (Reynolds, 1970, for example). Lithologic verification is performed a posteriori in the conventional method. In other words, after all the processings it is checked to determined if the pressure anomalies are not due to a lithologic variation.

French Patent 2,893,421 describes a method based on pre-stack inversion of seismic data. This method is difficult to implement, in particular the lithoseismic analysis of the seismic impedance cubes. This lithoseismic analysis, particularly delicate and long to implement, is an interpretation of the 3D seismic impedance cubes in terms of seismic facies with respect to the various lithologies which are encountered.

### SUMMARY OF THE INVENTION

The invention is an alternative method for evaluating fluid pressures in a subsoil zone from well data and seismic data. The method allows the drawbacks of the prior art to be overcome by providing a fluid pressure cube at a sufficiently precise scale for accounting for the lithology explicitly in the processing during drilling. The lithology is then reduced to a differentiation between argillaceous lithology and non-argillaceous lithology.

The invention relates to a method for evaluating fluid pressures in a subsoil zone from well data and seismic data. It comprises the following:

constructing a seismic P wave velocity cube and a seismic S wave velocity cube by a stratigraphic inversion of the seismic data, and determining from the velocity cubes a lithology cube that identifies argillaceous lithologies and non-argillaceous lithologies;

determining, from the well data and for each of the lithologies, relationships allowing estimation of the fluid pressure from the seismic P wave velocities; and evaluating the fluid pressures in the subsoil zone by constructing a fluid pressure cube by applying the relationships to the seismic P wave velocity cube as a function of the lithology cube.

According to an embodiment, the seismic data comprises at least one seismic cube discretizing the zone into elementary volumes identified by their horizontal (x, y) and vertical coordinates in time (t) ; the lithology cube is then constructed by determining a seismic S wave velocity cube by the stratigraphic inversion, and by applying a threshold value for the seismic P and S wave velocity ratio, to assign an argillaceous lithology to the elementary volumes having a ratio above this threshold, and a non-argillaceous lithology to the other volumes. The threshold can be 2 for example.

The relationships can have the form as follows:

$${P}_{pore}^{e} ( z ) = {P}_{pore}^{n} ( z ) \cdot \frac{{V}_{P}^{m} ( z )}{{V}_{P}^{n} ( z )}$$

wherein:
V_{P}^{m}(z) is a seismic P wave velocity measured in wells at a depth z
V_{P}ⁿ(z) is an estimated seismic P wave velocity assuming that there is no overpressure at depth z
P_{Pore}^{e}(z) is a fluid pressure measured in wells at depth z
P_{Pore}ⁿ(z) is an estimated fluid pressure assuming that there is no overpressure at depth z.

In argillaceous lithologies, V_{P}ⁿ(z) can be determined by the following:

identifying a depth interval where the fluid pressure is close to the hydrostatic pressure; and

defining the relationship V_{P}ⁿ(z) by a linear relationship in this interval.

In non-argillaceous lithologies, V_{P}ⁿ(z) can be determined by the following:

measuring the fluid pressure by logging in a reduced number of depths z and, for the depths z, calculating a fluid pressure equal to ρ.g.z, with ρ1030 kg/m³ and g≈9.81 m/s²;

measuring the seismic P wave velocity at the depths z; and

determining V_{P}ⁿ(z) by interpolating a line between depths where measuring the pore pressure is possible.

According to the invention, overpressure zones can be determined within the zone by constructing a confining pressure cube P_{conf}(x, y, t) and by detecting the overpressure zones when the fluid pressure is above a*P_{conf}(x, y, t), where a is a previously selected threshold. This threshold can be 0.9 for example.

### BRIEF DESCRIPTION OF THE DRAWINGS

Other features and advantages of the method according to the invention will be clear from reading the description hereafter of embodiments given by way of non limitative example, with reference to the accompanying figures wherein:

FIG. 1 is a general illustration of the various stages of the method,

FIG. 2 shows in detail the part of FIG. 1 corresponding to the seismic analysis loop (SAL);

FIG. 3 illustrates the ratio of the seismic velocities Vp and Vs as a function of Poisson's ratio (γ) for various lithologies (curve) wherein argillaceous lithologies (Arg) are distinguished from non-argillaceous lithologies (Narg) by a very high Vp/Vs ratio which is typically above 2 (horizontal line); and

FIGS. 4 and 5 show variations of the velocity (log Vp) of the seismic P waves as a function of depth (z) in a number of calibration wells wherein FIG. 4 illustrates argillaceous lithologies and FIG. 5 illustrates non-argillaceous lithologies.

### DETAILED DESCRIPTION OF THE INVENTION

The invention allows to evaluation of the fluid pressures of a subsoil zone from well data (such as logs) and seismic data. It mainly comprises the following:

1) Constructing seismic velocity cubes and an argillaceous lithology cube, by processing the seismic data.

2) Determining a relationship between the seismic P wave velocity and the fluid pressure for each lithology.

3) Constructing a fluid pressure cube (Pₚₒᵣₑ(x, y, t)).

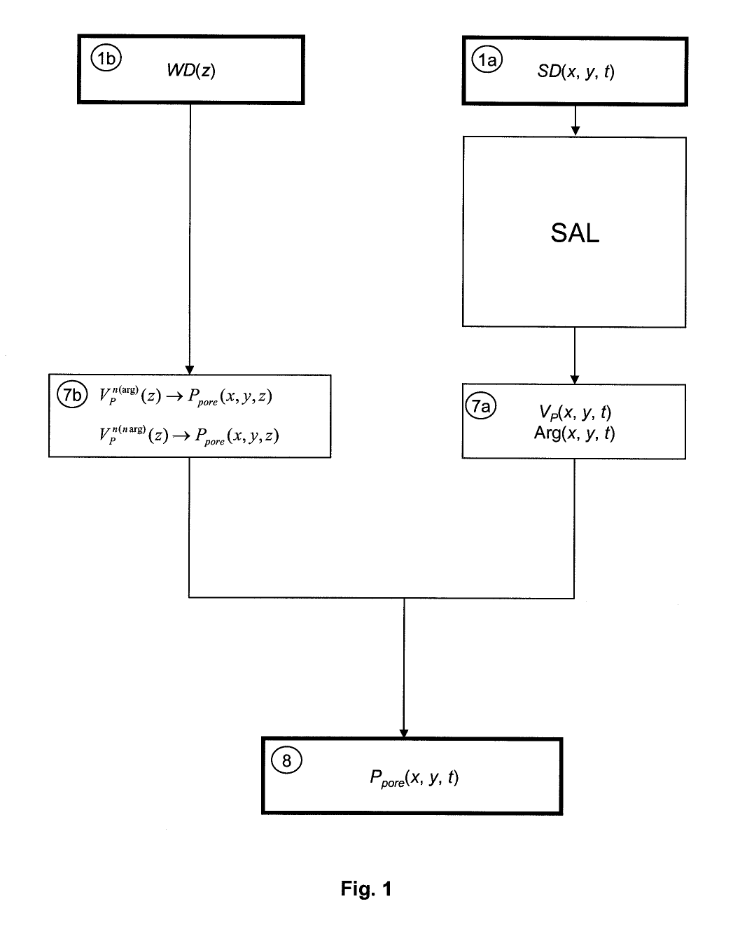

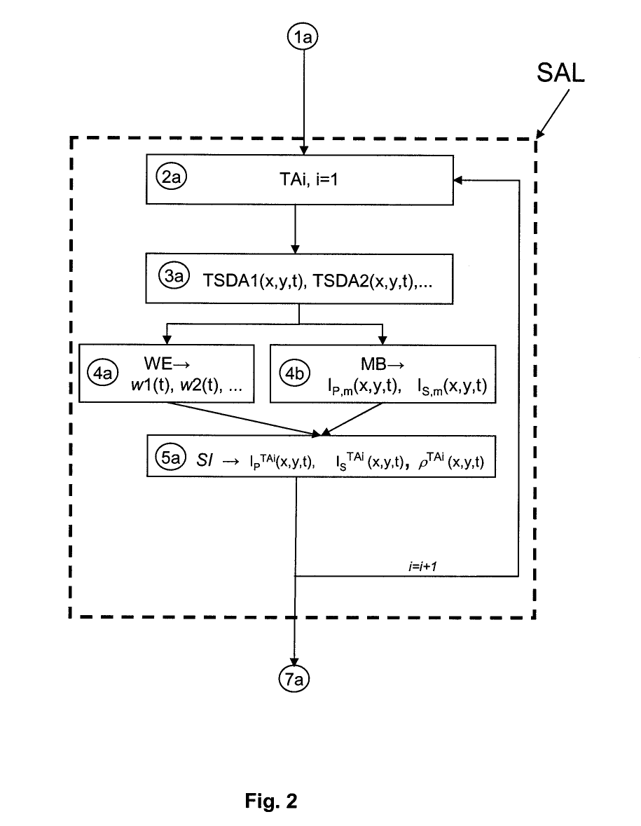

The various stages of the method are diagrammatically shown in FIGS. 1 and 2. FIG. 1 is a general illustration of the various stages of the method. These stages have two interconnected subsets of stages, that is, on the left side of FIG. 1, the stages corresponding to the well data processing and, on the right side of FIG. 1, the stages corresponding to the seismic data processing (detailed in FIG. 2). According to the usual convention, the rectangles contain the input data or the results obtained at a certain processing stage, the stage being identified by a figure possibly followed by a small roman letter (1a for example). These rectangles are connected by predominantly descending arrows oriented in the sequential direction of processing, from the input of the data (top of the figure) to the final output of the results (bottom of the figure). To clarify the description, the rectangles are sometimes accompanied by a very summary description of the technique (SI, . . . ) allowing proceeding from one result to the next.

According to the method, the fluid pressures are evaluated in a subsoil zone in the form of a cube discretizing the zone under study. This discretization divides the zone into elementary volumes identified by their horizontal (x,y) and vertical coordinates, either in time (t) or in depth (z).

### 1) Constructing a Seismic Velocity Cube and an Argillaceous Lithology Cube

It is well known that argillaceous or sandy-argillaceous media, typically of low permeability, are more favorable to the development of overpressures. On the other hand, sandy media, often of coarse lithology and especially sufficiently permeable, facilitate the flow of fluids contained in their pores, which prevents the development of overpressures. Thus, any method that does not first account for these geological realities is biased from the start and can only lead to at least partly erroneous results prior to a posteriori correction by taking into account the lithology variations.

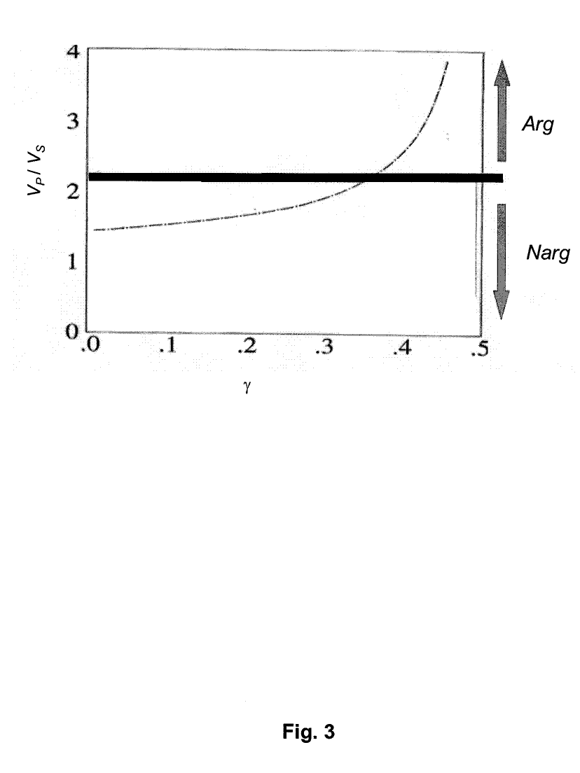

This argillaceous lithology can be taken into account (see FIG. 3) using the link that exists between the lithology and the ratio of the seismic P (I_{P}) and S (I_{S}) impedances, or in an equivalent manner the ratio of the seismic P (V_{P}) and S (V_{P}) wave velocities, because:

$$\frac{{I}_{P}}{{I}_{S}} = \frac{{V}_{P}}{{V}_{S}}$$

In fact, argillaceous lithologies are distinguished by very high Vp/Vs ratios, typically between 1.9 and 3, unlike other lithologies of sedimentary basins, that is mainly sands/sandstones with 1.6<Vp/Vs<1.75, dolomites with 1.80<Vp/Vs<1.85 and limestones with 1.85<Vp/Vs<2.00, a classification based on this ratio is pertinent. FIG. 3 illustrates the ratio of the seismic P and S velocities as a function of Poisson's ratio (γ) for various lithologies: the argillaceous lithologies (Arg) are distinguished from the non-argillaceous lithologies (Narg) by a very high Vp/Vs ratio, typically above 2.

In order to construct such a binary, argillaceous/non-argillaceous, lithology cube, seismic P and S wave velocity cubes are constructed from the seismic data by a technique known as stratigraphic inversion.

An Implementation Example is Described Hereafter.

According to a particular example, the seismic data, SD(x, y, t), are pre-stack 3D P wave monocomponent seismic data acquired during stage 1a.

The seismic data are first partially stacked by angle classes after preserved amplitude processing and NMO correction, using a known technique (not shown in the figures). Typically, there can be five angle classes, i.e. 0°-6°, 6°-12°, 12°-18°, 18°-24° and 24°-30°. According to the quality of the data, additional angle classes (30°-36°, etc.) can be added. Therefore at least five 3D cubes are used corresponding to each selected angle class.

Then a stratigraphic inversion (SI) within a seismic analysis loop (SAL) is carried out.

Conventionally, the zone is divided into time analysis intervals. Horizons, also referred to as seismic markers, are identified from the seismic data. These horizons indicate seismic discontinuities, lithologic or not, characterized by a seismic impedance variation. Therefore generally the part of the subsoil contained between two horizons is homogeneous as regards its petro-elastic properties is considered.

Thus, the underground zone is divided into several time analysis intervals delimited by seismic horizons, in order to obtain increased accuracy of results. Each time analysis interval is thus processed separately to identify very specific properties (wavelet, relationship between lithology and seismic data, etc.) and successively, to provide a global result described below. These time analysis intervals are generally selected below 500 ms, typically of the order of 300 ms to 400 ms.

Analysis is then started with a first time analysis interval, TA1 (stage 2a), and the 3D cubes corresponding to each of the selected angle classes are truncated to limit the first time analysis interval (stage 3a).

Then, from these truncated cubes (TSDA1(x, y, t), TSDA2(x, y, t), . . . ), a pre-stack stratigraphic inversion (SI) is performed using geological a priori information. This technique is known and it is possible to use for example the techniques proposed by:
Brac J. P. et al., 1988, Inversion with A Priori Information: An Approach to Integrated Stratigraphic Interpretation, Reservoir Geophysics R. E. Sheriff ed. Investigation in Geophysics, 7, SEG, Tulsa.
T. Tonellot, D. Mace, V. Richard, 1999, Prestack Elastic Waveform Inversion Using a Priori Information, 69th Ann. Internat. Mtg: Soc. of Expl. Geophys., paper 0231, p. 800-804.
Lucet, N., Dequirez, P. -Y. and Cailly, F., 2000, Well to Seismic Calibration: A Multiwell Analysis to Extract One Single Wavelet, 70th Ann. Internat. Mtg: Soc. of Expl. Geophys., 1615-1618.

This inversion type comprises two phases. The first phase (WE), according to the method described by Lucet et al. (2000), extracts for each truncated cube, that is for each angle class, the best wavelet (w1(t), w2(t), . . .) coherent with the data observed in the well (stage 4a). The second phase (MB), described by Tonellot et al. (1999), constructs an a priori 3D model (stage 4b) which is necessary for initiating and constraining the inversion in the next stage. It mainly has two 3D seismic impedance cubes, that is the P wave a priori impedance cube, denoted by I_{P,m} (x, y, t), and the S wave a priori impedance cube, denoted by I_{S,m} (x, y, t). Coordinates x and y are the two horizontal coordinates related to acquisition, typically on-line and cross-line. The third dimension is not depth z but the recording time t, directly related to the seismic measurement.

Finally, the inversion (SI) itself is performed. More precisely, knowledge of the wavelets and of the a priori model in the selected time analysis interval allows simultaneous inversion of all the 3D cubes (TSDA1(x, y, t), TSDA2(x, y, t) . . . ) via a pre-stack stratigraphic inversion according to the method described by:
Tonellot, T., Mace, D. and Richard, V., 2001, Joint Stratigraphic Inversion of Angle-Limited Stacks, 71st Ann. Internat. Mtg: Soc. of Expl. Geophys., 227-230.

This inversion produces two 3D seismic impedance cubes, that is the seismic P wave impedance cube denoted by I_{P}^{TA1}(x,y,t) and the seismic S wave impedance cube denoted by I_{S}^{TA1}(x,y,t) as well as a density cube ρ^{TA1}(x,y,t) (stage 5a).

After this conversion, all of the cubes I_{P}^{TA1}(x, y, t), I_{P}^{TA2}(x, y, t), . . . , I_{S}^{TA1}(x,y,t) I_{S}^{TA2}(x,y,t) etc., allow forming two impedance cubes and a density cube representative of the entire zone studied (stage 7a):
I_{P}(x,y,t)
I_{S}(x,y,t)
ρ(x,y,t)

By dividing the impedance cubes by the density cube, two seismic velocity cubes are obtained, that is the seismic P wave velocity cube denoted by V_{P}(x,y,t) and the seismic S wave velocity cube denoted by V_{S}(x,y,t) .

Furthermore, a third cube V_{P/S}(x,y,t) corresponding, at each discretization point, to the ratio of the two impedances, or in an equivalent manner to the ratio of the two seismic velocities is constructed from the two impedance cubes:

V_{P/S}(x,y,t)=V_{P}(x,y,t)/V_{S}(x,y,t)=I_{P}(x,y,t)/I_{S}(x,y,t)

Finally, from this cube V_{P/S}(x,y,t), an argillaceous lithology cube Arg(x,y,t) (stage 7a) is constructed. This binary cube indicates the location of the argillaceous facies and of the non-argillaceous facies.

Therefore, a ratio Vp/Vs threshold is selected. According to an example, which is in no way limitative of the invention because perfectly adjustable, a threshold value 2 is used as the lower limit value for ratio Vp/Vs in the argillaceous lithologies. Consequently, by convention, all the media characterized by a ratio Vp/Vs below 2 correspond to non-argillaceous lithologies.

After this seismic loop (SAL), the two cubes are obtained as follows:

V_{P}(x,y,t) and Arg(x,y,t).

2) Determining a Relationship Between the Measured Seismic P Wave Velocity and the Fluid Pressure, for Each One of the Two Lithologies (Stage 7b)

These relationships are established by processing well data and by taking into account two types of lithology. This is due to the fact that, in non-argillaceous lithologies, pressure measurements (by MDT logging for example) are possible, whereas the fluid pressures can only be estimated in argillaceous lithologies.

According to an example, the well data, WD(z), acquired during a stage 1b, mainly comprise:

the seismic velocities obtained from acoustic logs which are P wave velocity denoted by V_{P}(z), and optionally S wave velocity denoted by V_{S}(z); and

the fluid pressure denoted by Pₚₒᵣₑ(z); and

the type of lithology namely, argillaceous or non-argillaceous, denoted by Arg(z), where z designates depth.

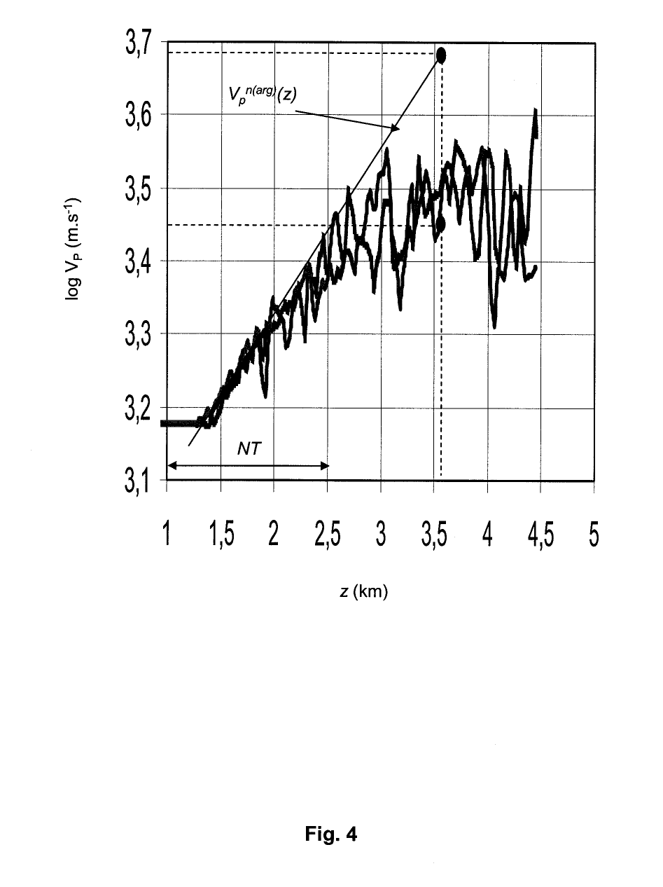

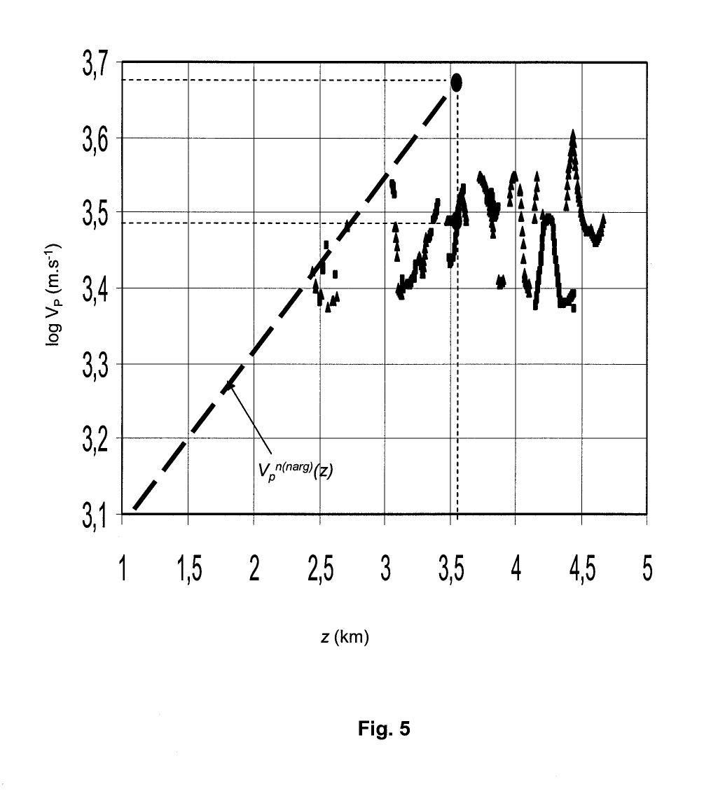

The detail of the new calibration method is illustrated by FIGS. 4 and 5 for these two types of lithology. More precisely, FIGS. 4 and 5 show the seismic P wave velocity variation (log Vp) as a function of depth (z) in a number of calibration wells.

According to an embodiment, which is in no way limitative of the invention because of the perfectly interchangeable with another relation connecting the seismic velocity and the pore pressure, the following relationship is used:

$${P}_{pore}^{e} ( z ) = {P}_{pore}^{n} ( z ) \cdot \frac{{V}_{P}^{m} ( z )}{{V}_{P}^{n} ( z )} \qquad ( 1 )$$

with:
V_{P}^{m}(z): seismic P wave velocity measured in wells at a depth z
V_{P}ⁿ(z): estimated seismic P wave velocity assuming that there is no overpressure at depth z
Pₚₒᵣₑ^{e}(z): fluid (pore) pressure measured in wells at depth z
Pₚₒᵣₑⁿ(z): estimated fluid (pore) pressure assuming that there is no overpressure at depth z.

The “normal” fluid pressure Pₚₒᵣₑⁿ(z) at the depth z under consideration is given by ρ_{w}gZ, where respectively ρ_{w}≈1030 kg/m³, g≈9.81 m/s² and Z designate the sea water density, the acceleration of gravity and the depth.

The seismic P wave velocity measured in wells at a depth z V_{P}^{m}(z) is known at the end of the stratigraphic inversion (cube V_{P}(x,y,t)).

It is thus possible to use the following relation, wherein V_{P}ⁿ(z) remains to be determined for each lithology:

$${P}_{pore}^{e} ( z ) = ρ \cdot g \cdot z \cdot \frac{{V}_{P}^{m} ( z )}{{V}_{P}^{n} ( z )} \qquad ( 2 )$$

### Estimation of V_{P}ⁿ(z)

The seismic P wave velocity is estimated assuming that there is no overpressure at depth z. The technique defines a relationship between Vp and z by processing well data. A curve representing the logarithm of the P wave velocity as a function of depth is determined from these well data, for each one of the two lithologies (argillaceous and non-argillaceous). For argillaceous lithologies, an example is illustrated in FIG. 4 and, for non-argillaceous lithologies, an example is illustrated in FIG. 5.

Then, for argillaceous lithologies (FIG. 4), a depth interval where the fluid pressure is close to the hydrostatic pressure is defined. This interval (NT) characterizes a behavior referred to as “normal”, that is without overpressure in the subsoil. This information is for example provided during drilling, geologists, or it is regional information known in other respects. In the example of FIG. 4, this interval extends from the surface to a depth below 2500 m. A linear relation log(V_{P})=f(z) is then defined in this interval. This relationship defines a normal trend for clays, denoted by V_{P}^{n(arg)}(z). That is, it expresses the evolution of the seismic P wave velocity in clays of the subsoil in the absence of an abnormally high pore pressure.

Then, for non-argillaceous lithologies (FIG. 5), the normal trend determination technique denoted by V_{P}^{n(n arg)}(z) comprises three stages:

measuring the fluid pressure, through MDT logging for example, in a reduced number of depths z and, for the depths z, calculating the fluid pressure referred to as “normal”, i.e. ρ.g.z;

measuring the seismic velocity of the P waves at these depths; and determining V_{P}^{n(n arg)}(z) using relationship (1) to calculate the velocity, referred to as “normal” at the same depths, and then by interpolating a line between the points where it has been possible to measure the pore pressure.

Thus, in clays:

$${P}_{pore}^{e} ( z ) = ρ \cdot g \cdot z \cdot \frac{{V}_{P}^{m} ( z )}{{V}_{P}^{n ( arg )} ( z )}$$

and in non-argillaceous lithologies:

$${P}_{pore}^{e} ( z ) = ρ \cdot g \cdot z \cdot \frac{{V}_{P}^{m} ( z )}{{V}_{P}^{n ( narg )} ( z )}$$

3) Constructing a Fluid Pressure Cube Pₚₒᵣₑ(x, y, t) (stage 8)

In order to construct fluid pressure cube Pₚₒᵣₑ(x, y, t), we scan argillaceous lithology cube Arg(x,y,t) is second as well as the velocity cube V_{P}(x,y,t) to obtain at each point x, y, t a lithology and velocity value P.

Depending on the lithology, the relation defined in stage 2 is applied to assign a pore pressure value to point x, y, t.

If the relationships are established in depth z, it is necessary to convert cubes Arg(x,y,t) and V_{P}(x,y,t) to depth. Such a time-to-depth conversion is a known conventional technique. The well data can also be converted to obtain relationships directly in time:

Thus, in clays:

$${P}_{pore}^{e} ( t ) = {P}_{pore}^{n} ( t ) \cdot \frac{{V}_{P}^{m} ( t )}{{V}_{P}^{n ( arg )} ( t )}$$

and in non-argillaceous lithologies:

$${P}_{pore}^{e} ( t ) = {P}_{pore}^{n} ( t ) \cdot \frac{{V}_{P}^{m} ( t )}{{V}_{P}^{n ( narg )} ( t )}$$

A fluid pressure cube can thus be constructed in time Pₚₒᵣₑ(x, y, t), or in depth Pₚₒᵣₑ(x, y, z):

For a point of coordinates x, y, z:
if Arg(x,y,z) indicates an argillaceous lithology, then:

$${P}_{pore} ( x , y , z ) = ρ \cdot g \cdot z \cdot \frac{{V}_{P} ( x , y , z )}{{V}_{P}^{n ( arg )} ( z )}$$

if Arg(x,y,z) indicates a non-argillaceous lithology, then:

$${P}_{pore} ( x , y , z ) = ρ \cdot g \cdot z \cdot \frac{{V}_{P} ( x , y , z )}{{V}_{P}^{n ( narg )} ( z )}$$

4) Determining Overpressure Zones

In time

From the method according to the invention, it is possible to predict, with a good spatial resolution, the possible overpressure zones that may be a danger, for example, during oil drilling for example. In fact, a confining pressure cube P_{conf}(x, y, t) can be obtained by the following equation:

$${P}_{conf} ( x , y , t ) = {\int }_{0}^{t} \frac{1}{2} ρ ( x , y , t ) {V}_{P} ( x , y , t ) g d t$$

$${P}_{conf} ( x , y , t ) = {\int }_{0}^{t} \frac{1}{2} {I}_{P} ( x , y , t ) g d t$$

Thus, since the 3D fluid pressure Pₚₒᵣₑ(x, y, t) and confining pressure P_{conf}(x, y, t) cubes are known, it is only necessary to apply a threshold criterion to the pore pressure, as the user chooses. The threshold can for example be selected equal to 0.9*P_{conf}(x, y, t), without it being limitative in the method because perfect adjustability thereof.

In depth

According to the method, it is also possible to obtain the same type of result in depth z and not in time t, which can be essential for defining the drilling conditions. In fact, the problem of switching from cubes in temporal coordinates to cubes in coordinates expressed in depth is a general problem that is well known in the field of seismic processing, and any method having proved its efficiency (vertical stretch, map migration, etc.) can be applied. In fact, such a conversion method simply allows going from the “space-time” to the “depth space” using the conversion function of the time t variable to the depth z variable. Thus, a depth cube of the fluid pressures Pₚₒᵣₑ(x, y, z) is readily obtained. This quantitative evaluation of the fluid pressures in the subsoil obviously allows location, in depth at this time, the abnormally high overpressure zones that may be a danger for oil drilling.

From this information, the trajectory of the wellbore can be modified to avoid these overpressure zones, or the drilling fluid injection pressure can be modified to compensate for the overpressures of the fluids in the subsoil.

According to another embodiment, overpressures are detected directly without constructing a pore pressure cube. In fact, the normal trends supply, for each lithology, a seismic P wave velocity value as a function of depth. Any difference between velocity value V_{P} resulting from the stratigraphic inversion and velocity V_{P} given by this normal trend is interpreted as an overpressure.

Advantages

The method according to the invention thus allows estimation of fluid pressures in a subsoil zone, as well as overpressure zones, in time or in depth, even for depths that have not yet been reached. The method is characterized by a high spatial resolution in relation to conventional methods based on velocity analyses. It allows defining the drilling conditions (trajectory, drilling fluid pressure, etc.) because it provides very accurate results by accounting for the lithology from the processing start in a quantitative manner, and not in a qualitative manner and a posteriori as with conventional approaches. Finally, the method exploits to the maximum data acquired on the seismic scale, which is close to direct measurement, to avoid scale change problems (geologic, reservoir and seismic).

It can also be noted that, in order to simplify the description, the particular example is illustrated from particular data that do not limit the invention. Other well or seismic data can be used, such as, for example, multi-component seismic data.

1-8. (canceled)

9. A method for evaluating fluid pressures in a subsoil zone from well data and seismic data, comprising:
constructing a seismic P wave velocity cube and a seismic S wave velocity cube by a stratigraphic inversion of the seismic data, and determining from the velocity cubes a lithology cube identifying argillaceous lithologies and non-argillaceous lithologies;
determining, from the well data and for each lithology, relationships allowing estimation of the fluid pressure from the seismic P wave velocities; and
evaluating the fluid pressures in the subsoil zone by constructing a fluid pressure cube by applying the relationships to the seismic P wave velocity cube as a function of the lithology cube.

10. A method as claimed in claim 9, wherein the seismic data comprise at least one seismic cube discretizing the subsoil zone into elementary volumes identified by horizontal (x, y) and vertical coordinates in time (t) thereof and wherein the lithology cube is constructed by determining the seismic S wave velocity cube by the stratigraphic inversion, and by applying a threshold value for a seismic P and S wave velocity ratio, to assign an argillaceous lithology to the elementary volumes having a ratio above the threshold, and a non-argillaceous lithology to other volumes.

11. A method as claimed in claim 10, wherein the threshold is 2.

12. A method as claimed in claim 9, wherein the relationships are::
$${P}_{pore}^{e} ( z ) {P}_{pore}^{n} ( z ) \cdot \frac{{V}_{P}^{m} ( z )}{{V}_{P}^{n} ( z )}$$
wherein:
V_{P}^{m}(z) is a seismic P wave velocity measured in wells at a depth z;
V_{P}ⁿ(z) is an estimated seismic P wave velocity assuming that there is no overpressure at depth z;
Pₚₒᵣₑ^{e}(z) is a fluid pressure measured in wells at the depth z; and
Pₚₒᵣₑⁿ(z) is an estimated fluid pressure assuming that there is no overpressure at the depth z.

13. A method as claimed in claim 10, wherein the relationships are::
$${P}_{pore}^{e} ( z ) = {P}_{pore}^{n} ( z ) \cdot \frac{{V}_{P}^{m} ( z )}{{V}_{P}^{n} ( z )}$$
wherein:
V_{P}^{m}(z) is a seismic P wave velocity measured in wells at a depth z;
V_{P}ⁿ(z) is an estimated seismic P wave velocity assuming that there is no overpressure at depth z;
Pₚₒᵣₑ^{e}(z) is a fluid pressure measured in wells at the depth z;
Pₚₒᵣₑⁿ(z) is an estimated fluid pressure assuming that there is no overpressure at the depth z;

14. A method as claimed in claim 11, wherein the relationships are::
$${P}_{pore}^{e} ( z ) = {P}_{pore}^{n} ( z ) \cdot \frac{{V}_{P}^{m} ( z )}{{V}_{P}^{n} ( z )}$$
wherein:
V_{P}^{m}(z) is a seismic P wave velocity measured in wells at a depth z;
V_{P}ⁿ(z) is an estimated seismic P wave velocity assuming that there is no overpressure at depth z;
Pₚₒᵣₑ^{e}(z) is a fluid pressure measured in wells at the depth z;
Pₚₒᵣₑⁿ(z) is an estimated fluid pressure assuming that there is no overpressure at the depth z.

15. A method as claimed in claim 12, wherein V_{P}ⁿ(z) in argillaceous lithologies is determined by:
identifying a depth interval where fluid pressure is related to hydrostatic pressure; and
defining relation V_{P}ⁿ(z) by a linear relationship in the depth interval.

16. A method as claimed in claim 13, wherein V_{P}ⁿ(z) in argillaceous lithologies is determined by:
identifying a depth interval where fluid pressure is related to hydrostatic pressure; and
defining relation V_{P}ⁿ(z) by a linear relationship in the depth interval.

17. A method as claimed in claim 14, wherein V_{P}ⁿ(z) in argillaceous lithologies is determined by:
identifying a depth interval where fluid pressure is related to hydrostatic pressure; and
defining relation V_{P}ⁿ(z) by a linear relationship in the depth interval.

18. A method as claimed in claim 12, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z), by interpolation of a line between the reduced number of depths, where pore pressure may be measured.

19. A method as claimed in claim 13, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z), by interpolation of a line between the reduced number of depths, where pore pressure may be measured.

20. A method as claimed in claim 14, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z), by interpolation of a line between the reduced number of depths, where pore pressure may be measured.

21. A method as claimed in claim 15, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z), by interpolation of a line between the reduced number of depths, where pore pressure may be measured.

22. A method as claimed in claim 16, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z), by interpolation of a line between the reduced number of depths, where pore pressure may be measured.

23. A method as claimed in claim 17, in non-argillaceous lithologies comprising:
measuring fluid pressure by logging in a reduced number of depths z and, for the reduced number of depths z, calculating a fluid pressure equal to ρ.g.z, with ρ≈1030 kg/m³ and g≈9.81 m/s²;
measuring the seismic P wave velocity at the reduced number of depths z; and
determining V_{P}ⁿ(z) by interpolation of a line between the reduced number of depths, where pore pressure may be measured.

24. A method as claimed in claim 9, wherein overpressure zones are determined within the overpressure zone by constructing a confining pressure cube P_{conf}(x, y, t) and by detecting when in the overpressure zones the fluid pressure is above a*P_{conf}(x, y, t) where a is a previously selected threshold.

25. A method as claimed in claim 10, wherein overpressure zones are determined within the subsoil zone by constructing a confining pressure cube P_{conf}(x, y, t) and by detecting when in the overpressure zone the fluid pressure is above a*P_{conf}(x, y, t) wherein a is a previously selected threshold.

26. A method as claimed in claim 11, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

27. A method as claimed in claim 12, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

28. A method as claimed in claim 13, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

29. A method as claimed in claim 13, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

30. A method as claimed in claim 15, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

31. A method as claimed in claim 16, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

32. A method as claimed in claim 17, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

33. A method as claimed in claim 18, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

34. A method as claimed in claim 19, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

35. A method as claimed in claim 20, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

36. A method as claimed in claim 21, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

37. A method as claimed in claim 22, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

38. A method as claimed in claim 23, wherein overpressure zones are determined within the subsoil zone by constructing a confining pressure cube P_{conf}(x, y, t) and by detecting when in the overpressure zones the fluid pressure is above a*P_{conf}(x, y, t) where a is a previously selected threshold.

39. A method as claimed in claim 24, wherein threshold a is 0.9.
